(19) United States
(12) Patent Application Publication
(10) Pub. No.: US 2026/0339993 A1
(43) Pub. Date: Oct. 29, 2026

(54) ADAPTIVE QUESTION RECOMMENDATION SYSTEM FOR CONVERSATIONAL ARTIFICIAL INTELLIGENCE ASSISTANTS

(71) Applicant: EXTREME NETWORKS, INC., San Jose, CA (US)

(72) Inventors: Ehsan NEZHADARYA, Thornhill (CA); Soheil SOLTANI, Waterloo (CA); Maria Carolina BESSEGA, Saint-Lambert (CA)

(73) Assignee: EXTREME NETWORKS, INC., San Jose, CA (US)

(21) Appl. No.: 19/368,395

(22) Filed: Oct. 24, 2025

Related U.S. Application Data
(60) Provisional application No. 63/796,711, filed on Apr. 29, 2025.

(51) Int. Cl. G06F 16/3329; G06F 40/295; G06F 40/58

(52) U.S. Cl. CPC G06F 16/33295; G06F 40/295; G06F 40/58

(57) ABSTRACT

Disclosed herein are system, method, and computer program product aspects intelligent question generation and recommendation in conversational artificial intelligence (AI) systems. An example embodiment may receive a user question from a user device. The embodiment may then assign the user question to a topic cluster in a database. The embodiment may then rank one or more topics within the topic cluster in the database from most to least relevant to the user question. The embodiment may then retrieve a first question from the database based on the ranked most relevant topic to the user question. The embodiment may then generate a second question by querying a large language model (LLM) based on the user question and a historical conversation associated with the user question. The embodiment may then generate a question recommendation for the user device based on a combination of the first question and the second question.

### CROSS-REFERENCE TO RELATED APPLICATIONS

This application claims the benefit of provisional U.S. Patent Application No. 63/796,711, titled “Adaptive Question Recommendation System for Conversational Artificial Intelligence Assistants” filed on Apr. 29, 2025, which is incorporated herein by reference in its entirety.

### BACKGROUND

Artificial intelligence (AI) conversational assistants may recommend questions to a user based on either the previous interactions in a conversation session with the user or based on the user's previous or current conversations and queries. However, AI conversational assistants often have trouble understanding users' true intentions. Additionally, AI conversational assistants may not personalize responses or stay relevant to the conversation engaged by a user, which may diminish the user experience.

### BRIEF DESCRIPTION OF THE FIGURES

The accompanying drawings are incorporated herein and form a part of the specification.

FIG. 1 illustrates a block diagram for an architecture of a question recommendation system 100, according to aspects of the present disclosure.

FIG. 2 illustrates a block diagram for a system processing sequence of a question recommendation and auto-completion service, according to aspects of the present disclosure.

FIG. 3 illustrates a flowchart for a data processing flow of a content-based (or retrieval-based) recommendation component, according to aspects of the present disclosure.

FIG. 4 illustrates a block diagram for a large language model (LLM)-based cleaning sequence of a content-based (or retrieval-based) recommendation component, according to aspects of the present disclosure.

FIG. 5 illustrates a flowchart for a data named entity recognition (NER) flow of a content-based (or retrieval-based) recommendation component, according to aspects of the present disclosure.

FIG. 6 illustrates a block diagram for a question recommendation service of a content-based (or retrieval-based) recommendation component, according to aspects of the present disclosure.

FIG. 7 illustrates a flowchart for a question extraction flow of a generation-based recommendation component, according to aspects of the present disclosure.

FIG. 8 illustrates a flowchart for a question generation flow of a generation-based recommendation component, according to aspects of the present disclosure.

FIG. 9 illustrates a flowchart of a method for generating a question as a recommendation to a user device, according to aspects of the present disclosure.

FIG. 10 illustrates an example computer system useful for implementing various aspects of the present disclosure.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product aspects, and/or combinations and sub-combinations thereof, for intelligent question generation and recommendation in conversational artificial intelligence (AI) systems. This disclosure is directed to an adaptive hybrid question recommendation system. This hybrid system may include question generation and recommendation in conversational AI systems but it can also work for any other systems for suggesting questions that a user might be interested in and/or that are relevant to a given topic or context. The hybrid question recommendation system aims to enhance personalization, increase engagement, and solve the various technical problems in conversational AI assistants or other systems such as, but not limited to, proposing unnatural questions, misclassifying topics, and providing irrelevant and non-diverse question recommendations to user devices.

In some aspects, the adaptive hybrid question recommendation system combines both a retrieval-based question recommendation subsystem and a generative-based question recommendation subsystem. During the retrieval-based question recommendation, an artificial intelligence (AI) assistant may collect the topics related to the questions the user device has asked during a conversation with the AI assistant. Weights may then be assigned to each topic based on how relevant, recent, and/or frequent each topic was during the conversation. User's conversation topics may then be sorted based on final weights and/or scores. A curated question pool may also be collected and stored in a database where each question in the pool may be assigned to few topics. Using the question pool and the extracted topics from a user's conversation, questions may be recommended by sampling from each selected topic. During the generative-based question recommendation, questions may be recommended based on the full conversation history, e.g., both questions asked by the user and AI assistant's response to those questions. Since this approach has more context about user's conversation, it can recommend more accurate and/or focused questions.

In some aspects, the adaptive hybrid question recommendation system may have offline and online components. Offline components may mainly correspond to automatic question cleaning and curation, and model training for the retrieval-based approach. Online components may include an inference mode of the machine learning models, generating LLM-based questions, and a rule-based fusion of these two approaches.

Conventional systems or products may provide a generic single question-based tool rather than a conversation-based recommendation tool to account for conversation history. Other conventional systems may be mainly generative-based and may hallucinate and generate content that may be factually incorrect, nonsensical, and/or unrelated to reality, even when presented with accurate information. In other words, these generative methods often lack the controllability of the retrieval-based approaches.

Conventional question recommendation systems may suffer from various technological challenges associated with question generation and/or recommendation. These technological challenges may include unnatural question generation in which the questions generated by the system do not reflect users' true intentions. The technological challenges may also include generating and/or recommending questions with inappropriately narrow or broad topic classification. For example, some narrow topics being generated by the conventional systems do not contain enough relevant questions, resulting in random recommendations that are not helpful. The technological challenges may also include a lack of personalization in question generation and/or recommendation. For example, conventional systems often use a basic lookup process which results in looking up questions by topic in a database during document ingestion with a lack of personalization. The technological challenges associated with the conventional systems may also fail to have sufficient data or API question coverage in which data questions being generated or recommended, particularly API-related ones, do not get personalized suggestions and instead receive random recommendations, diminishing the user experience. Finally, the technological challenges associated with the conventional systems may lack full conversation context in generating or recommendation questions in which the conventional systems may only recommend questions based on the last question topic (e.g., diverse and relevant questions are not taken into account).

To solve these technological challenges, the adaptive hybrid question recommendation system utilizes a combination of retrieval-based and generative-based recommendation approaches. The retrieval-based approach recommends questions from relevant topics by retrieving from a pool of curated questions. This subsystem recommends natural questions. The generative-based approach, on the other hand, generates new questions using LLMs. The generated questions are flexibly adapted to user's conversation history. Using a hybrid approach, the combination system takes the best of both retrieval-based and generative-based approaches. In particular, both retrieval and generative subsystems of the adaptive hybrid question recommendation system personalize the recommended questions based on user's unique conversation history and/or favourite topics to provide a more tailored experience. The adaptive hybrid question recommendation system can adapt itself to any changes in the topics that user is interested (e.g., based on at least the generative subsystem).

The adaptive hybrid question recommendation system also addresses the challenges in integrating retrieval-based and generative-based approaches based on how they learn and operate. For example, data synchronization between these two approaches may be challenging since retrieval-based systems often require structured data, while generative-based approaches thrives on unstructured data. Integrating different architectures and functionalities of retrieval-based and generative-based systems can also be a hurdle. This may require careful design and implementation to ensure that they can interact effectively. In some aspects, a fusion module in this adaptive hybrid question recommendation system may allow for easier integration of different subsystems by using APIs that allow these subsystems to communicate and interact with each other. The fusion module can also act as a bridge between different subsystems, allowing them to share data and collaborate effectively. In addition, the fusion module may fine-tune generative-based approaches based on the curated question pool stored in a database to make them more suitable for integration with retrieval-based systems.

In some aspects, the adaptive hybrid question recommendation system can recommend high-quality questions even to new users for whom there is not much behavioural or demographic information (e.g., it is robust to cold-start problems). Incorporating both the retrieval-based and generative-based approaches, the adaptive hybrid question recommendation system can have a balance in recommending questions that are both relevant to user's interests and diverse enough to give them the chance to explore new topics and get additional insights. The adaptive hybrid question recommendation system may also have the capability to adjust recommendation of questions both globally (e.g., based on user's global interests determined from the full conversation history or session with the user) and/or locally (e.g., based on the user's temporary interested indicated in the current or recent conversation or session).

In some aspects, the adaptive hybrid question recommendation system may also use recency, frequency, and/or relevance in the question recommendation process. For example, recency of user's favourite topics, frequency of the topics user has interacted with, and their relevance to each topic can be leveraged as a ranking metric to provide the most diverse and relevant questions to the user device. In some aspects, since questions in the question pool are curated and collected also based on their popularity (e.g., recency, frequency, etc.) and user's implicit or explicit feedback or insight on the answers generated by these questions, those curated questions can help users select questions for which AI models may already have a high-quality and efficient answer. In some aspects, the question pool or database in the retrieval subsystem may be continuously updated based on the new questions received by user devices. As user devices interact with the conversational AI assistant at front end, the questions asked by these user devices may be processed and cleaned in an offline pipeline. The question pool or database may then be updated based on these questions. Further, the question distribution in the question database may also be continuously updated based on any change in the distribution of user's questions and their interests over time. This mechanism may also assign weights to questions based on the implicit or explicit feedback received from user devices in which questions with higher weights may have higher chance of being recommended.

In summary, adaptive hybrid question recommendation system is technically advantageous to any conversational system and AI assistant with various technical benefits, including but not limited to, user exploration, user personalization, user engagement, user experience, user analytics, and/or guiding users toward an AI model's strengths. For example, the adaptive hybrid question recommendation system may help users explore more topics and get additional insights, create a more tailored suggestion or experience, retain users by fostering more meaningful and satisfying conversations, give inexperienced users examples of the questions they may ask, to better understand user's needs and interests, and/or recommend questions that can lead to higher quality and faster responses. These and other aspects of the present disclosure will be described in further detail below with respect to the accompanying drawings.

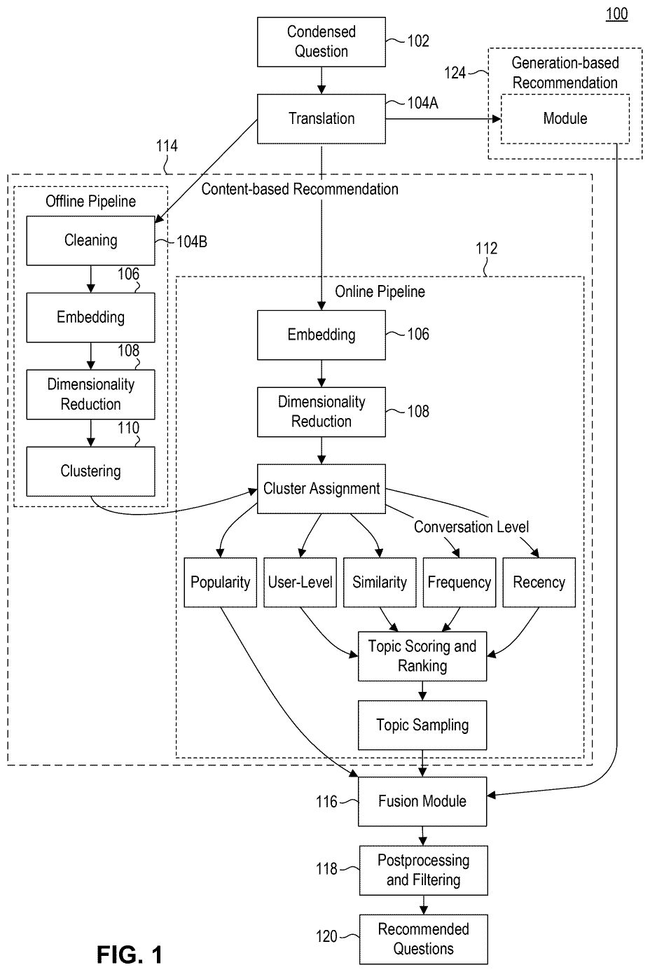

FIG. 1 illustrates a block diagram for an architecture of a question recommendation system 100, according to aspects of the present disclosure. Question recommendation system 100 may include, but is not limited, a preprocessing component 104, an embedding component 106, a dimensionality reduction component 108, a clustering component 110, a topic retrieval component 112, a content-based recommendation component 114, a generation-based recommendation component 124, a fusion module 116, and/or a post-processing component 118.

When a condensed question 102 is received (e.g., from a user device), preprocessing component 104 may be activated to pre-process the condensed questions. Both content-based recommendation component 114 and generation-based recommendation component 124 may be activated to recommend questions based on the processed condensed question. A fusion module 116 may then fuse the recommendation results from both the content-based recommendation component and the generation-based recommendation component. In some aspects, generation-based recommendation component 124 may use an LLM-based generative approach that to take the conversation history as input and generate a synthetic question as output. In some aspects, an A/B testing (may also known as split testing), can be used to compare the recommended questions from the content-based recommendation component and the generation-based recommendation component to determine which performs better based on user behavior, helping the fusion model to make data-driven decisions. The fusion model may leverage the results of historical A/B testing for subsequent recommendations. A post-processing component 118 may then be activated to complete the post-processing steps and send the recommendations to the used device.

Preprocessing component 104 may include a translation component 104A and a cleaning component 104B. The translation component may detect whether the input language from condensed question 102 is English (or any other target languages) or not. If the language is English, the translation component may keep it as original and send the cleaning component. If the detected language is not English, the translation component may translate it to English via a large language model (LLM). It would be appreciated by a person with an ordinary skill in the art that the preprocessing component can be adapted to any other target languages. In some aspects, the LLM may be include, but is not limited to, ChatGPT, Bard, Llama, Bing Chat, and/or any other models that would be appreciated by a person with an ordinary skill in the art.

In some aspects, preprocessing component 104 may map the noisy questions from condensed question 102 to a high-quality people also ask (PAA)-like recommendation question. The preprocessing component may separate question queries from the condensed question from non-question queries and then remove uninformative queries (e.g., as part of the non-question queries), such as “Thank you, ok, thank you for your help.” Preprocessing component 104 may also normalize the words in the condensed question. For example, different forms of a word may be normalized or converted into a standard base form, like converting “running,” “runs,” and “ran” to “run.” “CompanyName” or “CompanyName Company” may be normalized to “CompanyNameCompany.” Component 104 may additionally remove the questions with a low feedback score in which the low feedback score may indicate the questions with low answer quality or those which have received negative user feedback.

Embedding component 106 may embed the preprocessed questions. The embedding component may use various embedding approaches, including but not limited to, semantic vector embedding and/or word embedding using Bag of Words (BoW). Semantic vector embedding may use pre-trained Bidirectional Transformer-based models, including but not limited to, OpenAI's text-embedding-ada-002, all-MiniLM-L6-v2, and/or any other embedding models that would be appreciated by a person with an ordinary skill in the art. The BoW embedding may use term frequency-inverse document frequency (TF-IDF) with an extension of ranking or retrieval algorithm, such as best matching 25 (BM25). In particular, BM25 is a bag-of-words retrieval function that ranks a set of documents based on the query terms appearing in each document, regardless of their proximity within the document. It would be appreciated by a person with an ordinary skill in the art that other embedding approaches and/or ranking or retrieval algorithms could be used by embedding component 106.

Dimensionality reduction component 108 may reduce the dimension of embedding vectors to improve the clustering accuracy and speed. The dimensionality reduction component may use uniform manifold approximation and projection (UMAP) which is non-linear dimension reduction technique for this dimension reduction. It would be appreciated by a person with an ordinary skill in the art that other dimensionality reduction approaches (e.g., either linear or non-linear) could be used by dimensionality reduction component 108.

Clustering component 110 may cluster embedding vectors of the questions into different categories. The clustering component may use various clustering approaches, including but not limited to, K-means and/or hierarchical density-based spatial clustering of applications with noise (HDBSCAN) to cluster those embedding vectors. It would be appreciated by a person with an ordinary skill in the art that other clustering approaches could also be used by clustering component 106

Topic retrieval component 112 may retrieve the topics that are related to the user question. In some aspects, the topic retrieval component may be part of a content-based recommendation component 114. After obtaining the reduced dimension embedding vectors (e.g., as part of an online pipeline), the topic retrieval component may assign the reduced embedding vectors to different categories based on at least one of a popularity, a user-level, and/or a conversation level in which the conversation level may further include a similarity level, a frequency level, and/or a recency level. In some aspects, the cluster assignment may be based on a scoring and a ranking of both user or conversional-levels of user's question embedding to each cluster or topic. The topic retrieval component 112 may then score and rank the topics based on the scores associated with the different users or conversation levels. The topics distribution for each conversation or user may then be retrieved based on the scored topics computed between the online reduced dimension embedding vectors and a user-level or conversion history. The user-level or conversation-level history may be stored as clusters of embedding in a database as part of an offline pipeline. In some aspects, after retrieving the topics distribution, topic retrieval component 112 may then sample the topics based on the ranking so that the top-k topics can be output for any fusion or post processing steps. In some aspects, the ranking can be re-calculated from the new list of weights or scores.

In some aspects, the conversation-level used in topic retrieval component 112 may refer to a recommendation approach that user query or question may be first mapped to top-k clusters or topics, and any new questions may then recommended to the user from these top-k topics, based on the previous topics in the conversation. The user-level used in topic retrieval component 112 may refer to a recommendation approach that those top-k clusters or topics may be assigned to each user based on the history of user queries and interactions with the system, and any new questions may then be recommended based on these top-k clusters or topics. In some aspects, a recency factor may also be considered into as part of the conversation-level and/or user-level approaches in which a higher weight may be given to more recently interacted topics. In some aspects, popularity-based recommendation may also be applied by topic retrieval component 112 in which the most popular topics or questions may be recommended based on the cluster size.

In some aspects, each user question in the conversation may be assigned a topic or a cluster. A score or weight may be then given to each topic based on the various criteria, including but not limited to, a topic similarity, a topic frequency, and/or a topic recency. For example, topic similarity may indicate the similarity of a question to its corresponding topic. A higher similarity may mean the questions is closer to cluster center in which a higher topic similarity may also mean the higher final topic score. Topic frequency may be computed by aggregating the topic similarity scores for multiple occurrences of the topic in which the topic frequency may indicate how many times each topic is used over a period of time. Also, a higher frequency may mean the higher the final topic score. In addition, topic recency may indicate how recent was the last time the topic was used in which the more recent topics may be assigned with higher final topic scores. Topic recency may be calculated using topic order and updated with cumulative least recently used (LRU) cache. In some aspects, leveraging the topic similarity, topic frequency, and topic recency, the final topic score may be computed as:

$$T = {e}^{- \text{?}} {\sum }_{{T}_{J}} {T}_{s}$$

$$\text{?} \text{indicates text missing or illegible when filed}$$

where Ts, Tf, Tt respectively denote topic similarity, topic frequency and topic time since last interaction. The latter is computed via the “order” of the topic (e.g., vs time) within a queue. As a new topic is interacted with the user, the topic is added to a queue. To account for order resetting, when an already existing topic is interacted with again, an LRU data structure is employed. The new data structure, called “Cumulative LRU (CLRU)”, accumulates the topic similarities the old topic with that of the new one, if the topic already exists in the queue.

In some aspects, topic ranking scoring and ranking performed by topic retrieval component 112 may aim to increase the probability of sampling questions from high-score topics and reduce the probability for low-score. The topics for recommendation may be ranked by their score values and topics may then be sampled from the recommended topic list based on the scores assigned to each topic. In some aspects, the topic ranks may be maintained throughout the sampling process in which scores may be first mapped to probability values via a softmax function.

In some aspects, question sampling performed by topic retrieval component 112 may aim to recommend questions that may be good representatives of their clusters. For each sampled topic, a single question may be sampled from the offline curated question database. In some aspects, to overcome challenges that the sampled questions may not be completely relevant to users asked in weighted sampling, in each proposed topic, question sampling performed by topic retrieval component 112 may look for questions whose embedding vector is closest to user's last question. This may be achieved via a weighted sampling, where weights are an aggregate of at least one of probabilities with which curated questions belong to their clusters (soft labels) and/or user's implicit or explicit feedback for each curated question. The implementation of weighted sampling from a PostgreSQL question table is illustrated as Listing 2.

Fusion module 116 may fuse the recommendations from both content-based recommendation component 114 and generation-based recommendation component 124. The fusion module may combine recommendation results (e.g., topics or questions) from both recommendation components as the final recommendations or adaptively select results from either one of the recommendation components.

Post-processing component 118 may back-translate the recommended topics or questions to original language if the original language of condensed questions 102 is not the target language (e.g., English). This back-translation may identify and correct any discrepancies or errors, ensuring final recommended questions 120 accurately conveys the original meaning to the user device.

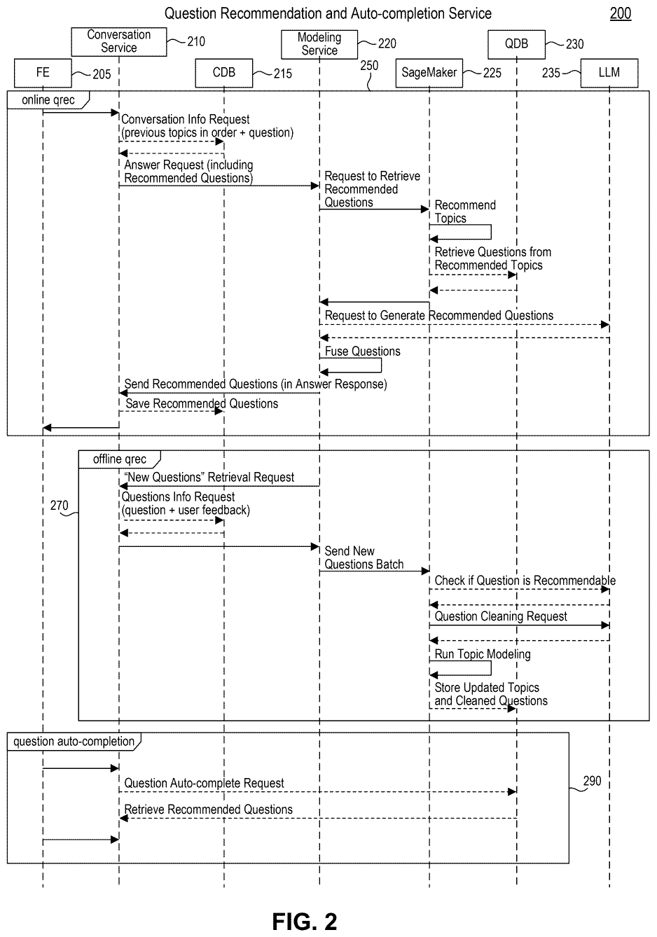

FIG. 2 illustrates a block diagram for a system processing sequence 200 of a question recommendation and auto-completion service, according to aspects of the present disclosure. In some aspects, question recommendation system 100 (the system) which performs question recommendation, may include a collaboration across front end 205, conversation service 210, conversation database 215, modeling service 220, unified platform 225, question database 230, and/or LLM 235. In some aspects, unified platform 225 may include, but is not limited to, SageMaker, Azure, Vertex AI, Databricks, Dataiku, and/or other service platforms.

In some aspects, in online question recommendation stage 250, when front end 205 initiates a conversation with conversation service 210, conversation service 210 may request the conversation information associated with the front end at conversation database 215. The conversation information may include previous topics in order and the previous questions engaged with the front end. Conversation database 215 may return the conversation information back to conversation service 210. Conversation service 210 may request answer including recommendation questions from modeling service 220.

Modeling service 220 may then request to retrieve the recommended questions from SageMaker 225 in which SageMaker 225 may identify or recommend relevant topics based on the request. SageMaker 225 may then retrieve, from a question database 230, questions from the identified or recommended topics. Question database 230 may return the retrieved questions back to SageMaker 225 and the SageMaker may then return the questions back to modeling service 220. Modeling service 220 may then query an LLM 235 to generate and/or refine the recommendation questions based on the retrieved questions from the recommendation topics. The LLM may return the generated or refined recommendation questions back to modeling service 220. Modeling service 220 may then fuse questions and send the fused recommended questions (e.g., in answer response) back to conversation service 210. Conversation service 210 may save the recommended questions to conversation database 215 and also send the questions back to front end 205.

In some aspects, in offline question recommendation stage 270, modeling service 220 may send a retrieval request for new questions to conversation service 210. Conversation service 210 may then request the information of the new questions (e.g., including questions and any user feedbacks) from conversation database 215. The conversation database may return the question information back to the conversation service. The conversation database may then send the question information to modeling service 220. The modeling service may send the new questions in a batch to SageMaker 225. SageMaker 225 may then query LLM 235 to check if the new question is recommendable and the LLM may return the response back to the SageMaker. SageMaker 225 may also query LLM 235 or send a request to clean the new question and the LLM may return the cleaned question back to the SageMaker. SageMaker 225 may run topic modeling and then store the updated topics and cleaned questions to question database 230.

In some aspects, in question auto-completion stage 290, when front end 205 initiates a conversation with conversation service 210, conversation service 210 may send a question auto-complete request to question database 230 for retrieval of the recommendation questions. The recommended questions may then be retrieved from the question database and sent back to the conversation service. In addition, conversation service 210 may send the recommended questions back to front end 205.

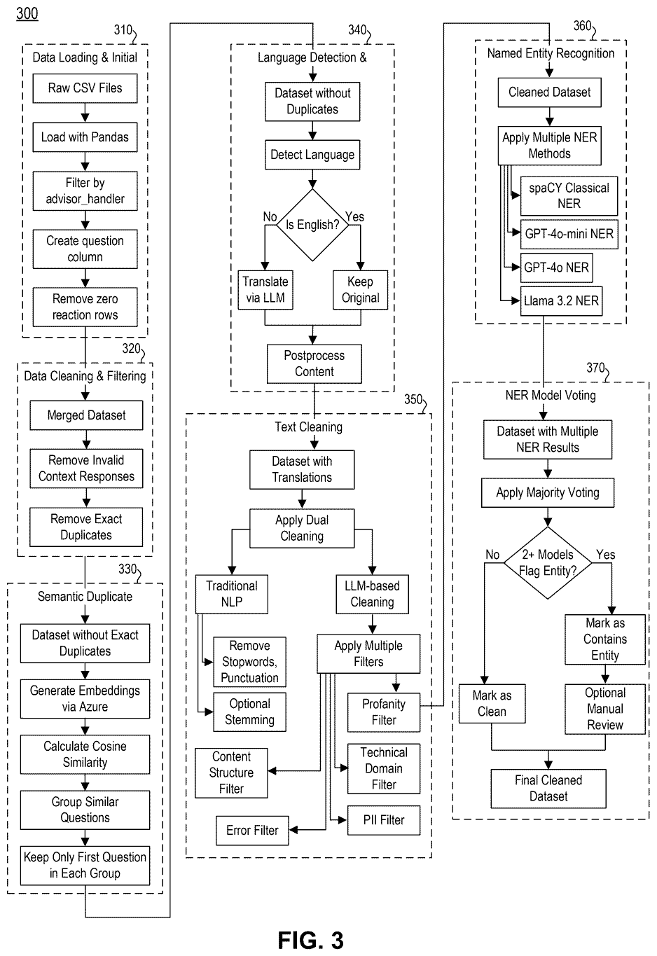

FIG. 3 illustrates a flowchart for a data processing flow 300 of a content-based (or retrieval-based) recommendation component 114, according to aspects of the present disclosure. Data processing flow 300 may include, but is not limited to, data loading and initialization 310, data cleaning and filtering 320, data semantic deduplication 330, data language detection 340, data text cleaning 350, data named entity recognition (NER) 360, and/or data NER model voting 370.

In data loading and initialization 310, content-based recommendation component 114 may process from multiple files and consolidate the relevant information into a single output file. The input and/or output files may include, but are not limited to, comma separated values (CSV) files, tabular files, and/or any other types of files with any suitable formats. In some aspects, the input files (e.g., the CSV files) of the data loading and initialization may include a list of CSV file paths containing the source data, and the output file may be the path to the consolidated output CSV file. The content-based recommendation component may determine the appropriate value for a specified column (e.g., question) based on the corresponding fields (e.g., condensed_question and/or interaction_message). For example, the “question” column may then be populated with the value from “condensed_question” field if it is not empty; otherwise, the columns may use the value from “interaction_message” field.

In some aspects, content-based recommendation component 114 may load the raw files using a data analysis library, including but not limited to, a Pandas library and/or other libraries that would be appreciated by a person with an ordinary skill in the art. The content-based recommendation component may filter the loaded CVS files by a field, such as “condensed_question,” “interaction_message,” “advisor_handler,” and/or another field and then create the question column based on the field. The content-based recommendation component may then remove zero reaction rows based on the created question column. In addition, the processed row may be written to the output file.

In data cleaning and filtering 320, content-based recommendation component 114 may merge multiple output files from data loading and initialization 310. The content-based recommendation component may then remove invalid context responses from the merged multiple files. An invalid context response or error may typically arise when a program of the content-based recommendation component attempts to perform an action (e.g., accessing data of the files) outside of a valid or expected environment or state, often due to incorrect initialization, timing, or parameters. Content-based recommendation component 114 may remove exact duplicates from the files.

In data semantic deduplication 330, after exact duplicates have been removed in data cleaning and filtering 320, content-based recommendation component 114 may identify and eliminate redundant data points that are semantically similar but of different textual representation. In some aspects, the content-based recommendation component may generate embedding using various embedding approaches, including but not limited to, semantic vector embedding, word embedding like BoW, Word2Vec, GloVe, FastText and/or sentence embedding models (e.g., Sentence Transformers, BERT). The content-based recommendation component may then compute similarity scores between the vector embedding and representations. The similarity scores include cosine similarity or any other similarity metrics that would be appreciated by a person with an ordinary skill in the art. The content-based recommendation component may then identify the potential semantic duplicates or group similar questions by comparing the similarity metrics with a pre-defined threshold. When the similarity scores are within the pre-defined threshold, the question pair may be identified as semantic duplicates; otherwise, the question pairs may be determined as distinct when the scores exceed the threshold. In addition, after identifying or grouping the semantic duplicated questions, only a limited number of questions (e.g., the first question) in each group may be kept for subsequent steps.

In data language detection 340, content-based recommendation component 114 may detect languages from the question dataset without duplicates. In some aspects, multiple-language detection may be applied to the dataset to ensure questions are available in English or any other target languages for consistent processing in the subsequent steps. For example, if the language is detected as English (e.g., or any other target languages) in the question dataset, the content-based recommendation component may keep the question dataset for content post processing; otherwise, the content-based recommendation component may translate the question dataset via an LLM.

In some aspects, the translation may be conducted by using Azure OpenAI API, but any other LLM APIs could be also used. The key components of the translation within data language detection 340 may include, but are not limited to, special handling of some terms related to LLM content filtering (e.g., prevention of LLM content filtering), progress tracking and error logging, and/or configurable processing parameters. The error handling of the translation may handle logs errors for individual row processing failures, continue processing remaining rows if one fails, maintain detailed logging of all operations, and/or validate input files before processing. The progress tracking or monitoring may track at least a progress of a number of rows (e.g., ever 100 rows) and/or detailed logging of file processing start or end, translation operations, errors and warnings, and/or final processing statistics. In some aspects, a batch processing may be used to detect and translate the language of the questions for large question datasets.

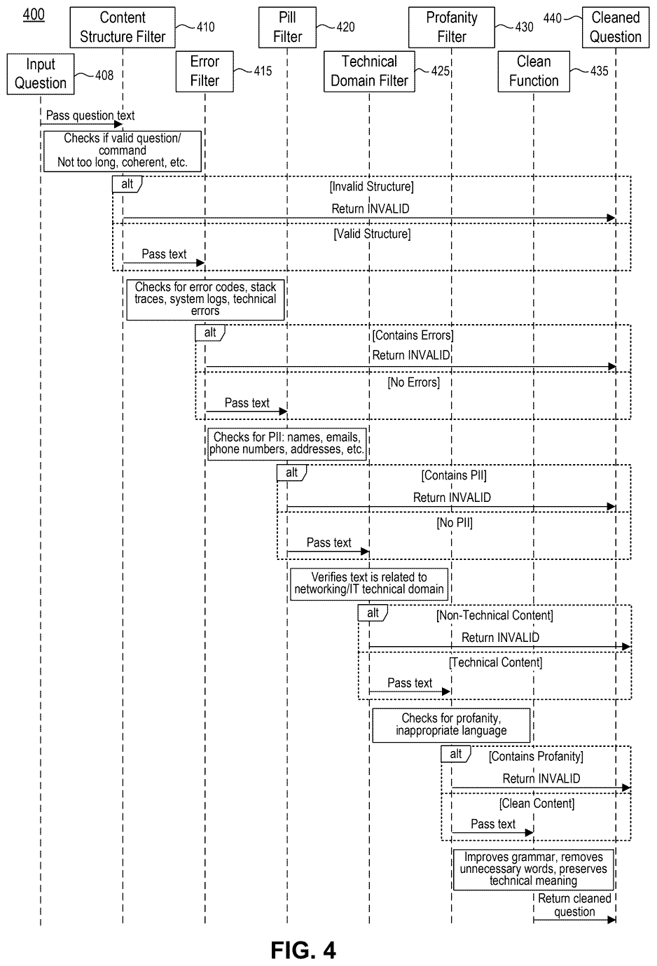

In data text cleaning 350, content-based recommendation component 114 may aim to standardize, normalize, and filter questions before further processing. Question dataset with translations has been provided as the input for the content-based recommendation component as this step. Content-based recommendation component 114 may apply dual cleaning to those translated questions, including but not limited to, a traditional natural language processing (NLP)-based cleaning and/or an LLM-based cleaning. The LLM-based cleaning may be further described in FIG. 4 as below.

For example, the traditional NLP-based clean may refer to a rule-based cleaning using standard NLP techniques. In some aspects, the steps of this NLP-based cleaning may include, but are not limited to, converting text to lowercase, removing punctuation, tokenizing the text, removing stopwords, and/or apply an optional stemming. The benefits of this NLP-based clean may include a fast processing of the text, a consistent preprocessing of the text, and/or applying the language-independent approach that may work regardless of what the languages of the questions are.

In some aspects, the steps of the LLM-based cleaning may include, but are not limited to, applying grammar and spelling correction, removing unnecessary words, preserving technical intent, maintaining critical terminology, and/or ensuring clarity and conciseness of the text. In order to perform this cleaning process, multiple filters have been applied by content-based recommendation component 114 in using this LLM-based cleaning approaches. The filters may include a content structure filter, an error filter, a personally identifiable information (PII) filter, a technical domain filter, and/or a profanity filter. Based on those filters, the LLM-based cleaner may remove questions that at least contain specific error codes or messages, include personal identifiable information, and/or are technically too specific or narrow. The benefits of this LLM-based clean may include a context-aware cleaning, an advanced semantic understanding, an intelligent filtering, and/or handling of complex language scenarios.

In some aspects, the cleaning pipeline of content-based recommendation component 114 in data text cleaning 350 may include, but is not limited to, converting questions to strings, handling empty or NaN inputs (e.g., by filling or removing those NaN inputs), and/or applying both NLP-based and LLM-based cleaning methods in parallel. The output format of data text cleaning 350 may include a first column with original questions, a second column with a NLP-cleaned version of the questions, and/or a third column with a LLM-cleaned version of the questions. Such preprocessing goals of this cleaning pipeline may include, but are not limited to, standardizing question format, removing noise and irrelevant information, preserving core technical intent, and/or preparing for subsequent recommendation stages.

The configuration options of applying data text cleaning 350 may also include a language selection, a stemming toggle, a batch processing, and/or a dynamic checkpoint mechanism. Content-based recommendation component 114 may also apply approaches to optimize the performance of the data text cleaning, including but not limited to, a batch processing of the questions, asynchronous or synchronous cleaning of the questions, dynamic configuring of the LLM providers, and/or a built-in error handling and logging.

In some aspects, content-based recommendation component 114 may use both NLP-based and LLM-based cleaning methods for comprehensive analysis of the questions, monitor cleaning effectiveness, and/or periodically update cleaning strategies based on a consideration and monitoring of computational resources and latency. Content-based recommendation component 114 may also supports multiple LLM providers, apply modular design for easy extension, apply comprehensive logging, and/or support flexible system or model configurations. In addition, more advanced filtering mechanisms and multilingual support may be developed into content-based recommendation component 114 for data text cleaning 350.

In data NER 360, content-based recommendation component 114 may apply multiple NER methods to the cleaned question dataset from data text cleaning 350. In some aspects, the NER methods may include, but are not limited to, spaCy Classical NER, GPT-40-mini NER, GPT-40 NER, Llama 3.2 NER, and/or any other NER approaches that would be appreciated by a person with an ordinary skill in the art.

In data NER model voting 370, content-based recommendation component 114 apply a majority voting of the question datasets with multiple NER results. In some aspects, when there are a minimum of NER models (e.g., at least half of the NER models) that flag entity to the cleaned question dataset from the multiple NER results, the cleaned question may be marked as containing entity; otherwise, the cleaned question may be marked as clean. In some aspects, the cleaned question being marked as containing entity may then be sent for any additional reviews (e.g., which can be an automated review or a manual review). After the review, the clean question datasets and/or the questions datasets with multiple NER results may be stored as the final cleaned dataset for any subsequent recommendation processes.

FIG. 4 illustrates a block diagram for an LLM-based cleaning sequence 400 of a content-based (or retrieval-based) recommendation component 114, according to aspects of the present disclosure. In some aspects, the LLM-based cleaning may apply multiple filters to input questions 405, including but is not limited to, a content structure filter 410, an error filter 415, a PII filter 420, a technical domain filter 425, and/or a profanity filter 430. The LLM-based cleaning may also include a clean function 435 before obtaining final cleaned questions 440.

In some aspects, content-based recommendation component 114 may pass input questions 405 to a sequence of filters for questions cleaning. To check if the valid question or commend is of an appropriate length or coherency and/or other content quality criteria, content-based recommendation component 114 may pass input questions 405 to a content structure filter 410. If content structure filter 410 indicates that the structure of the input questions is invalid, content-based recommendation component 114 may output input questions 405 as invalid cleaned questions 440. If content structure filter 410 indicates that the structure of the input questions is valid, content-based recommendation component 114 may pass the input questions (e.g., the text of the questions) to an error filter 415. Error filter 415 may check for error codes, stack traces, system logs, and technical errors to identify whether input questions 405 contain any errors. If error filter 415 indicates that the input questions contains any errors, content-based recommendation component 114 may output input questions 405 as invalid cleaned questions 440. If error filter 415 indicates that the input questions do not contain any errors, content-based recommendation component 114 may pass the input questions to a PII filter 420. PII filter 420 may check for PII of input questions 405, including names, emails, phone numbers, addresses, etc. If PII filter 420 indicates that the input questions contains any PII, content-based recommendation component 114 may output input questions 405 as invalid cleaned questions 440. If PII filter 420 indicates that the input questions do not contain any PII, content-based recommendation component 114 may pass the input questions to a technical domain filter 425. Technical domain filter 425 may verify whether text of input questions 405 is related to networking and/or any IT technical domains. If technical domain filter 425 indicates that the input questions do not contain any technical-related contents, content-based recommendation component 114 may output input questions 405 as invalid cleaned questions 440. If technical domain filter 425 indicates that the input questions contain technical content, content-based recommendation component 114 may pass the input questions to a profanity filter 430. Profanity filter 430 may check for profanity and/or any inappropriate language usage of input questions 405. If profanity filter 430 indicates that the input questions contains the profanity, content-based recommendation component 114 may output input questions 405 as invalid cleaned questions 440. If profanity filter 430 indicates that the input questions do not contain any profanity, content-based recommendation component 114 may pass the input questions to a clean function 435. Clean function 435 may improve grammar, remove unnecessary words, and/or preserve technical meaning of input questions 405. In addition, content-based recommendation component 114 may output the cleaned questions after performing the clean function.

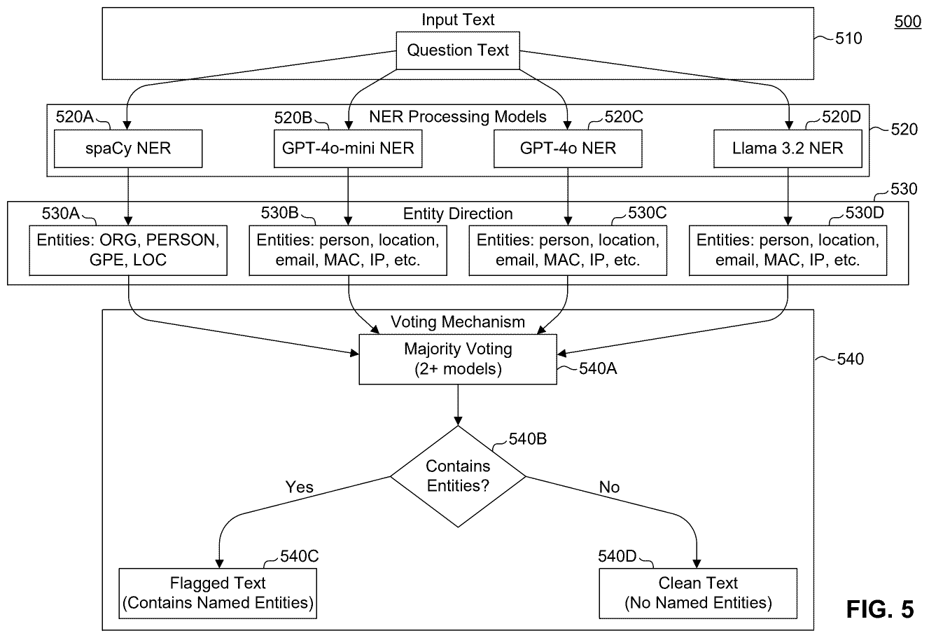

FIG. 5 is a flowchart illustrating a data NER flow 500 of a content-based (or retrieval-based) recommendation component 114, according to aspects of the present disclosure. Data NER flow 500 may include, but is not limited to, NER processing models 520, entity detection 530, and/or voting mechanism 540.

In data NER flow 500, input (e.g., question) text 510 may be received by content-based recommendation component 114. The input text may then be sent by the content-based recommendation component to various NER processing models 520. The NER processing models may include, but is not limited to, spaCy Classical NER 520A, GPT-40-mini NER 520B, GPT-40 NER 520C, Llama 3.2 NER 520D, and/or any other NER models that would be appreciated by a person with an ordinary skill in the art. The NER processing models may detect entities from the question text. For example, spaCy Classical NER 520A may detect entities 530A, such as ORG, PERSON, GPE, and/or LOC. GPT-40-mini NER 520B may detect entities 530B, such as person, location, email, MAC, IP, etc. GPT-40 NER 520C may detect entities 530C, such as person, location, email, MAC, IP, etc. Llama 3.2 NER 520D may detect entities 530D, such as person, location, email, MAC, IP, etc. The entity detection results may then be sent and organized by the content-based recommendation component to voting mechanism 540. The voting mechanism may apply majority voting 540A to entity detection results 530A-530D. The voting mechanism may determine, at 540B, whether a minimum number (e.g., at least two models in this case) of NER processing models in majority voting 540A have detected entities in the results. When the minimum number of NER processing models detect entities, the question text may be flagged as containing name entities in 540C; otherwise, the question text may be marked as clean (e.g. or no named entities) in 540D.

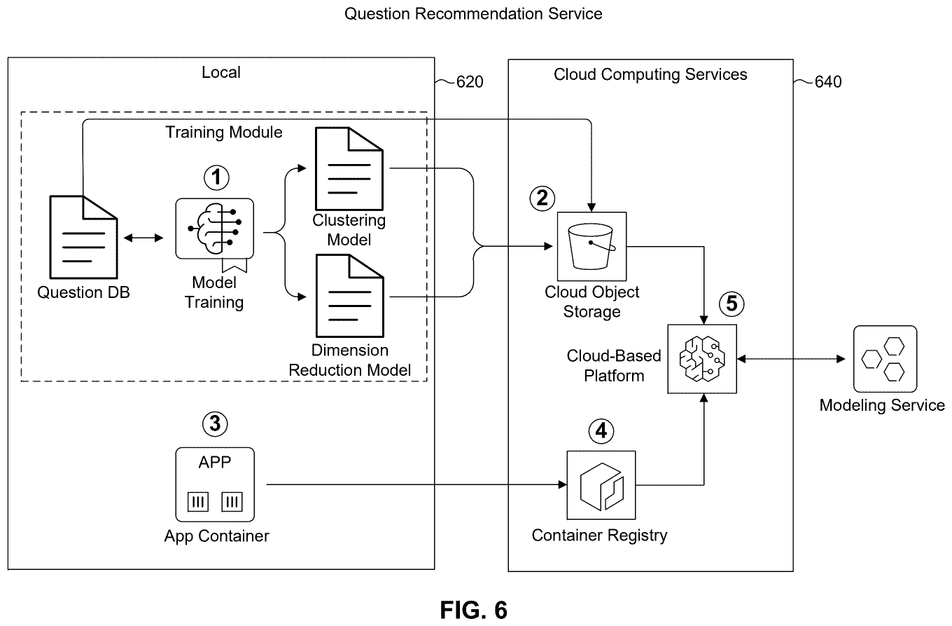

FIG. 6 is a block diagram illustrating a question recommendation service 600 of a content-based (or retrieval-based) recommendation component 114, according to aspects of the present disclosure. Question recommendation service 600 may include a training stage 620 (e.g., may happen at local or remote servers) and a model deployment and management stage 640. In some aspects, at training stage 620, question database may be used for training the clustering model that can assign the question into different topic or question clusters. In some aspects, a dimension reduction model can also be trained using the question database. After the clustering model and the dimension reduction model have been trained, content-based recommendation component 114 may transmit or store the training clustering model and the dimension reduction model to a cloud, for example Amazon S3. Other cloud service would be appreciated by a person with an ordinary skill in the art. In some aspects, a comprehensive suite of tools, from data preparation to model deployment and management, may also be provided to the question recommendation service. The tools may include, but are not limited to, an application container, a container registry, and/or a unified service platform that bring together at least datasets, models and any integrated development or hosted environments.

In some aspects, during the deployment or management of question recommendation service 600, the clustering and/or dimension reduction model may not be trained frequently. The reason for this can be that the cluster numbers may change after each training session and a question can be mapped to different cluster numbers after the model is changed. In case there is a small issue with the recommended questions, those questions can be removed from the question database. In some aspects, if new questions should be added to the question database, their cluster IDs should be obtained first, by running the cluster assignment function. The questions along with their estimated cluster IDs and similarity scores can then be added to the database.

In some aspects, during the deployment of question recommendation service 600, if an interaction timestamp (e.g., which is retrieved from a conversation database) is older than the deployment timestamp of the new model, the interaction topic may be recalculated or updated. In some aspects, after each model update, all or at least a part of the previous interaction topics in the database may be updated as well. The previous question or interaction topics may be stored in a separate database from the conversation service database.

In some aspects, content-based recommendation component 114 may operate as a continuous learning system, for example, a self-learning system (e.g., either supervised or unsupervised). In this self-learning system, questions may be automatically curated and added to clusters using methods, including but not limited to, hierarchical clustering, k-means clustering, and any other clustering variations to create balanced and diverse datasets. This continuous self-learning system may allow the recommender component to stay current with the latest topics and trends. For example, to implement this self-learning system, content-based recommendation component 114 may perform preparation steps, including but not limited to, collecting questions from various sources, preprocessing the text of the questions, extracting features from those preprocessed questions, and/or clustering the extracted features or the questions into different clusters.

In some aspects, the questions may be collected from any offline or online data storages (e.g., a conversation service database). Text preprocessing may include, but is not limited to, removing stop words, punctuation, and/or converting the text to lowercase. Feature extraction may further include, but is not limited to, identifying the most important words in each question, expanding the keywords using a thesaurus or word embedding to capture semantic similarity of the text, classifying questions based on their structures (e.g., “what”, “how”, “why”). Other features, including question length or search relevance, may be used for content-based recommendation.

After feature extraction, clustering approaches with a suitable distance metric (e.g., cosine similarity, Euclidean distance for measuring semantic similarity between questions, etc.) can be used to cluster the extracted features into different clusters (e.g., related to topics and trends). Such clustering approaches can be regularly trained or fine-tuned based on the extracted feature data from the various offline or online resources. This self-learning system helps overcome technical challenges associated with manual dataset curation, such as high labor costs and scalability issues.

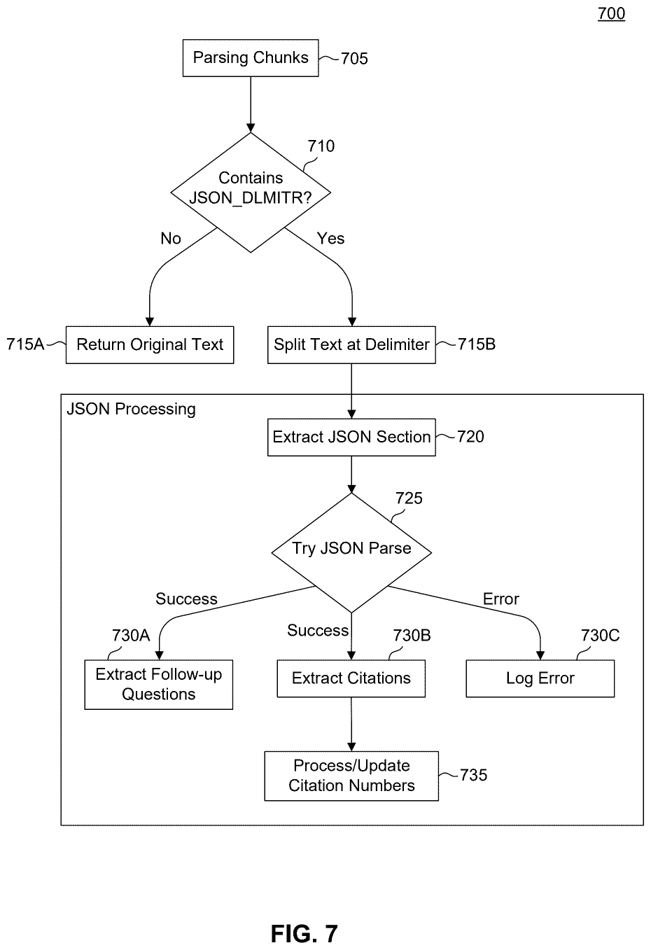

FIG. 7 is a flowchart illustrating a question extraction flow 700 of a generation-based recommendation component 124, according to aspects of the present disclosure. In 705, generation-based recommendation component 124 may parse the question into chunks. This chunk parsing may refer to a process of breaking down text of the question into smaller, manageable units or “chunks” for easier processing and analysis. In 710, the generation-based recommendation component may then determine whether the chunks contain a JSON delimiter. If the chunks do not contain any JSON delimiters, the original text of the question may be returned in 715A; otherwise, the text of the question may be split at delimiter in 715B. In 720, the generation-based recommendation component may extract JSON section from the split text. In 725, the generation-based recommendation component may try JSON parse to the JSON section extracted. If JSON parse has been successfully applied, in 730A, follow-up questions may be extracted, and meanwhile in 730B, citations may also be extracted. In 735, those citations may then be processed to update the citation numbers. If JSON parse has not been successfully applied, in 730C, the error logs may be displayed.

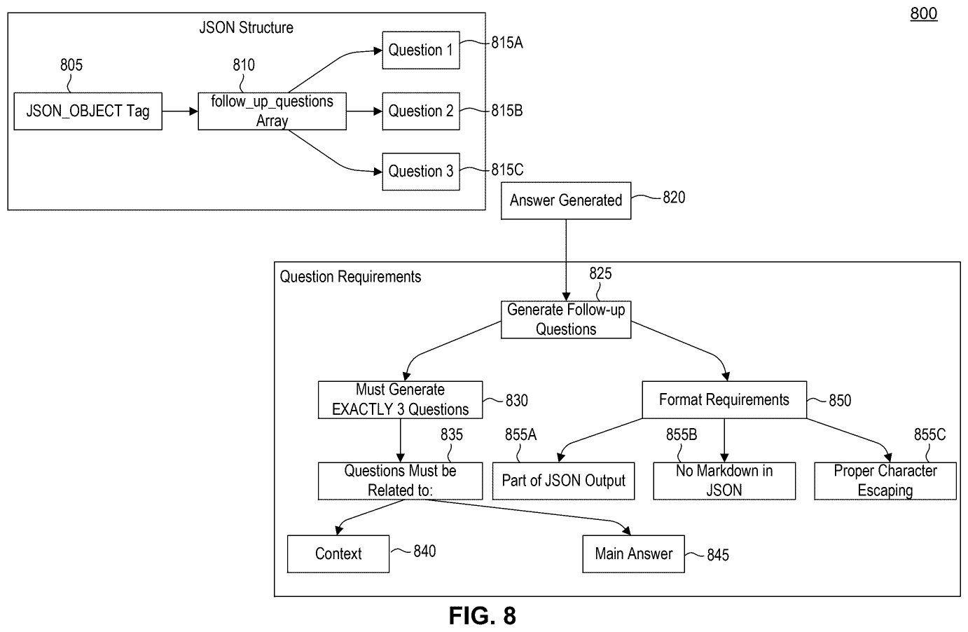

FIG. 8 is a flowchart illustrating a question generation flow 800 of a generation-based recommendation component 124, according to aspects of the present disclosure. In 805, generation-based recommendation component 124 may receive tag of the JSON object. In 810, generation-based recommendation component 124 may then generate an array of follow-up questions in which the array may be processed to generate multiple questions 815A-815C. When generating those questions, the generation-based recommendation component, in 820, may generate citations (e.g., associated to the content relative to the user input or question), the recommended questions and main answer to the questions at the same time. To separate the citations, the follow-up questions, and/or the answers from each other, additional processing steps may be conducted by the generation-based recommendation component.

In some aspects, in 825, generation-based recommendation component 124 may then filter or generate follow-up questions from the generated citations, recommended questions, and main answer to the questions. In 830, generation-based recommendation component 124 may be instructed to generate an exact (e.g., or a minimum or maximum or a ranged) number of questions. In 835, further constrains may be added to the generation process that the questions may be related to context 840 and main answer 845. In 850, the generation-based recommendation component may also be instructed to generate the questions based on a format requirement, including but not limited to, the generated questions may be part of the JSON output 855A, the generated questions may not have any markdowns in JSON 855B, and/or the generated questions may have a proper character escaping 855C.

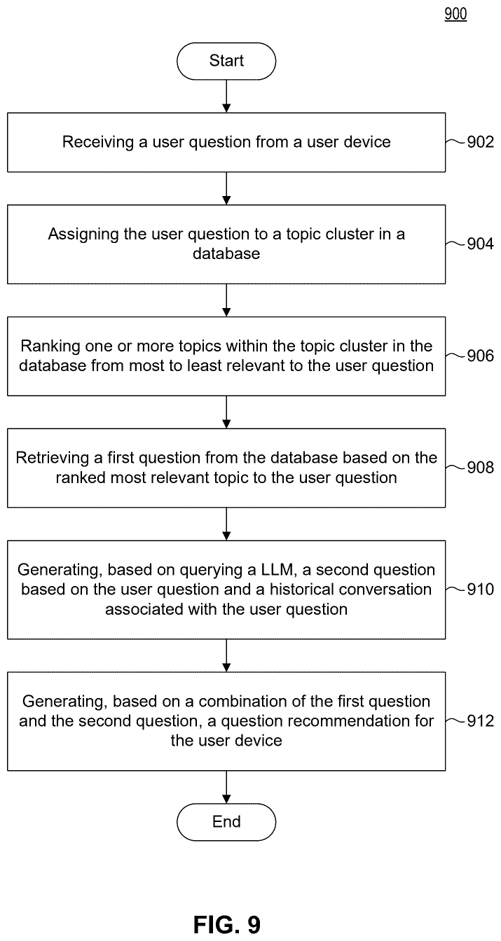

FIG. 9 is a flowchart illustrating a method 900 for generating a question as a recommendation to a user device, according to aspects of the present disclosure. Method 900 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 9, as will be understood by a person of ordinary skill in the art. Method 900 shall be described with reference to at least FIG. 1 and FIG. 2. However, method 900 is not limited to that example aspect.

In 902, a user question may be received by question recommendation system 100 from a user device. In 904, the user question may be assigned, based on a distance metric between an embedding of the user question and an embedding of a topic cluster in the database, by question recommendation system 100 to a topic cluster in a database.

In some aspects, the database may be generated by question recommendation system 100. The database generation may include, but is not limited to, importing, from one or more data sources into a first dataset, one or more data files including one or more questions and one or more topics associated with the one or more questions; generating a second dataset by applying a first data cleaning to the first dataset; generating one or more embeddings for the one or more topics in the second dataset; grouping the one or more embeddings in the second dataset into one or more groups based on the distance metric; translating, by querying the LLM, a language of the one or more questions in the second dataset to a default language for the database; generating a third dataset by applying a second data cleaning to the second dataset; and identifying, by querying the LLM or a NLP model, a set of NER results for the one or more questions in the third dataset. In some aspects, a group of the second dataset may include the one or more questions associated with the one or more topics within the distance metric.

In some aspects, in response to a majority of results of the set of NER results for the one or more questions having a named entity, the database generated by question recommendation system 100 may further include, but is not limited to, flagging the one or more questions in the third dataset as having the named entity; and storing the third dataset into the database. In some aspects, the one or more questions being flagged in the third dataset may locate the named entity associated with the first question for retrieving the first question from the one or more questions in the database.

In some aspects, the first data cleaning applied by question recommendation system 100 may include deleting a row of the first data set with a zero response, an invalid response, or a duplicated response from the first dataset. In some aspects, the second data cleaning applied by question recommendation system 100 may further include, but is not limited to, deleting at least one of a stopword or a punctuation of the one or more questions from the second dataset; stemming the one or more questions in the second dataset; applying a plurality of filters to the one or more questions in the second dataset; and applying a grammar checking and a spelling correction to the one or more questions in the second dataset. In some aspects, the plurality of filters may include, but is not limited to, a content structure filter, an error filter, PII filter, a technical domain filter, or a profanity filter.

In 906, in response to the assigning, one or more topics within the topic cluster in the database may be ranked by question recommendation system 100 from most to least relevant to the user question based on a topic score associated with the one or more topics. In some aspects, the topic score may be generated by question recommendation system 100 for each of the one or more topics based on at least a topic similarity, a topic frequency, or a topic recency.

In 908, a first question may be retrieved by question recommendation system 100 from the database based on the ranked most relevant topic to the user question. In 910, a second question may be generated by question recommendation system 100 by querying a LLM based on the user question and a historical conversation associated with the user question. In 912, the question recommendation may be generated for the user device by question recommendation system 100 based on a combination of the first question and the second question. In some aspects, the combination of the first question and the second question may include an adaptive selecting and/or reordering of the questions from both retrieval-based and generative-based recommended questions.

In some aspects, a dimensionality of the embedding of the user question may be reduced by question recommendation system 100 based on a dimension reduction model. A dimensionality of the embedding of the topic in the database may also be reduced by question recommendation system 100 based on the dimension reduction model.

In some aspects, a text may be generated by question recommendation system 100 by querying the LLM based on the second question and the historical conversation associated with the user question. The text may include one or more follow-up questions associated with the second question and one or more citations associated with the one or more follow-up questions. A third question may also be extracted, by question recommendation system 100, from the one or more follow-up questions based on the one or more citations and a format instruction from the user device. In addition, the historical conversation associated with the user question may be updated by question recommendation system 100 by incorporating at least one of the second question or the third question into the historical conversation.

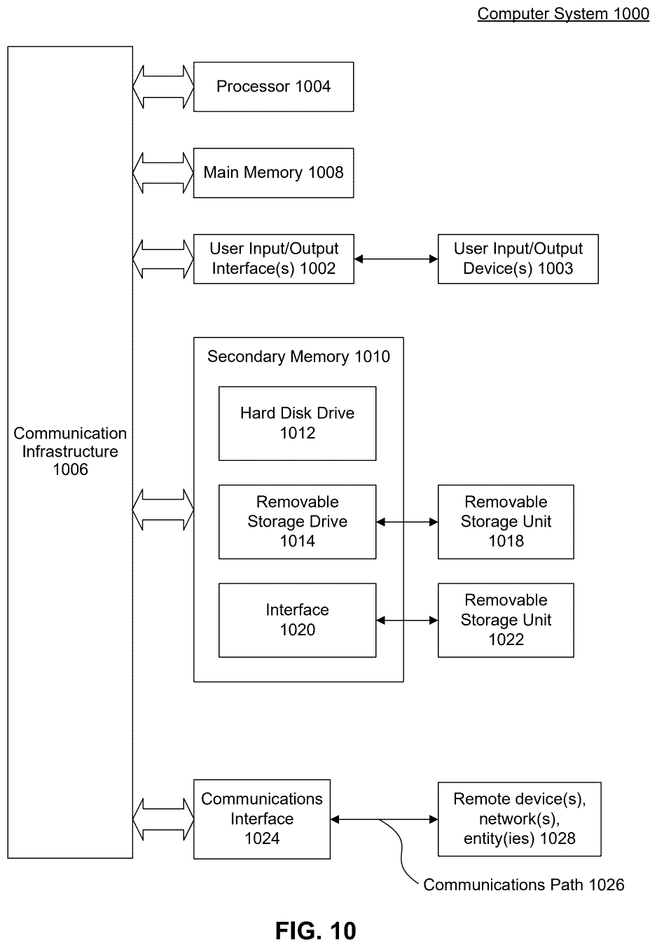

Various aspects may be implemented, for example, using one or more well-known computer systems, such as computer system 1000 shown in FIG. 10. For example, aspects herein using the text summarization system may be implemented using combinations or sub-combinations of computer system 1000. Also or alternatively, one or more computer systems 1000 may be used, for example, to implement any of the aspects discussed herein, as well as combinations and sub-combinations thereof. A “module,” as the term is used herein, is a computational element that performs one or more functions according to computer readable instructions stored on one or more memories or other non-transitory computer-readable media.

Computer system 1000 may include one or more processors (also called central processing units, or CPUs), such as a processor 1004. Processor 1004 may be connected to a communication infrastructure or bus 1006.

Computer system 1000 may also include user input/output device(s) 1003, such as monitors, keyboards, pointing devices, etc., which may communicate with communication infrastructure 1006 through user input/output interface(s) 1002.

One or more of processors 1004 may be a graphics processing unit (GPU). In an aspect, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 1000 may also include a main or primary memory 1008, such as random access memory (RAM). Main memory 1008 may include one or more levels of cache. Main memory 1008 may have stored therein control logic (i.e., computer software) and/or data.

Computer system 1000 may also include one or more secondary storage devices or memory 1010. Secondary memory 1010 may include, for example, a hard disk drive 1012 and/or a removable storage device or drive 1014. Removable storage drive 1014 may be a floppy disk drive, a magnetic tape drive, a compact disk drive, an optical storage device, tape backup device, and/or any other storage device/drive.

Removable storage drive 1014 may interact with a removable storage unit 1018. Removable storage unit 1018 may include a computer usable or readable storage device having stored thereon computer software (control logic) and/or data. Removable storage unit 1018 may be a floppy disk, magnetic tape, compact disk, DVD, optical storage disk, and/any other computer data storage device. Removable storage drive 1014 may read from and/or write to removable storage unit 1018.

Secondary memory 1010 may include other means, devices, components, instrumentalities or other approaches for allowing computer programs and/or other instructions and/or data to be accessed by computer system 1000. Such means, devices, components, instrumentalities or other approaches may include, for example, a removable storage unit 1022 and an interface 1020. Examples of the removable storage unit 1022 and the interface 1020 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 1000 may further include a communication or network interface 1024. Communication interface 1024 may enable computer system 1000 to communicate and interact with any combination of external devices, external networks, external entities, etc. (individually and collectively referenced by reference number 1028). For example, communication interface 1024 may allow computer system 1000 to communicate with external or remote devices 1028 over communications path 1026, which may be wired and/or wireless (or a combination thereof), and which may include any combination of LANs, WANs, the Internet, etc. Control logic and/or data may be transmitted to and from computer system 1000 via communication path 1026.

Computer system 1000 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 1000 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 1000 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some aspects, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 1000, main memory 1008, secondary memory 1010, and removable storage units 1018 and 1022, as well as tangible articles of manufacture embodying any combination of the foregoing. Such control logic, when executed by one or more data processing devices (such as computer system 1000 or processor(s) 1004), may cause such data processing devices to operate as described herein.

Based on the teachings contained in this disclosure, it will be apparent to persons skilled in the relevant art(s) how to make and use aspects of this disclosure using data processing devices, computer systems and/or computer architectures other than that shown in FIG. 10. In particular, aspects can operate with software, hardware, and/or operating system implementations other than those described herein.

It is to be appreciated that the Detailed Description section, and not any other section, is intended to be used to interpret the claims. Other sections can set forth one or more but not all exemplary aspects as contemplated by the inventor(s), and thus, are not intended to limit this disclosure or the appended claims in any way.

While this disclosure describes exemplary aspects for exemplary fields and applications, it should be understood that the disclosure is not limited thereto. Other aspects and modifications thereto are possible, and are within the scope and spirit of this disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative aspects can perform functional blocks, steps, operations, methods, etc. using orderings different than those described herein.

References herein to “one aspect,” “an aspect,” “an example aspect,” or similar phrases, indicate that the aspect described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it would be within the knowledge of persons skilled in the relevant art(s) to incorporate such feature, structure, or characteristic into other aspects whether or not explicitly mentioned or described herein. Additionally, some aspects can be described using the expression “coupled” and “connected” along with their derivatives. These terms are not necessarily intended as synonyms for each other. For example, some aspects can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary aspects, but should be defined only in accordance with the following claims and their equivalents.

What is claimed is:

1. A computer-implemented method for generating a question recommendation to a user device, comprising:
receiving, by one or more processors, a user question from the user device;
assigning, based on a distance metric between an embedding of the user question and an embedding of a topic cluster in a database, the user question to the topic cluster in the database;
in response to the assigning, ranking one or more topics within the topic cluster in the database from most to least relevant to the user question based on a topic score associated with the one or more topics;
retrieving a first question from the database based on the ranked most relevant topic to the user question;
generating, by querying a large language model (LLM), a second question based on the user question and a historical conversation associated with the user question; and
generating, based on a combination of the first question and the second question, the question recommendation for the user device.

2. The computer-implemented method of claim 1, further comprising generating the topic score for each of the one or more topics based on at least a topic similarity, a topic frequency, or a topic recency.

3. The computer-implemented method of claim 1, further comprising generating the database, wherein the generating the database comprises:
importing, from one or more data sources into a first dataset, one or more data files comprising the one or more questions and the one or more topics associated with the one or more questions;
generating a second dataset by applying a first data cleaning to the first dataset;
generating one or more embeddings for the one or more topics in the second dataset;
grouping, based on the distance metric, the one or more embeddings in the second dataset into one or more groups, wherein a group of the second dataset comprises the one or more questions associated with the one or more topics within the distance metric;
translating, by querying the LLM, a language of the one or more questions in the second dataset to a default language for the database;
generating a third dataset by applying a second data cleaning to the second dataset;
identifying, by querying the LLM or a natural language processing (NLP) model, a set of named entity recognition (NER) results for the one or more questions in the third dataset;
in response to a majority of results of the set of NER results for the one or more questions having a named entity, flagging the one or more questions in the third dataset as having the named entity, wherein the flagged one or more questions in the third dataset locate the named entity associated with the first question for retrieving the first question from the one or more questions in the database; and
storing the third dataset into the database.

4. The computer-implemented method of claim 3, wherein the applying the first data cleaning comprises:
deleting, from the first dataset, a row of the first data set with a zero response, an invalid response, or a duplicated response.

5. The computer-implemented method of claim 3, wherein the applying the second data cleaning comprises:
deleting at least one of a stopword or a punctuation of the one or more questions from the second dataset;
stemming the one or more questions in the second dataset;
applying a plurality of filters to the one or more questions in the second dataset, wherein the plurality of filters comprise a content structure filter, an error filter, a personally identifiable information (PII) filter, a technical domain filter, or a profanity filter; or
applying a grammar checking and a spelling correction to the one or more questions in the second dataset.

6. The computer-implemented method of claim 1, further comprising:
reducing, based on a dimension reduction model, a dimensionality of the embedding of the user question; and
reducing, based on the dimension reduction model, a dimensionality of the embedding of the topic in the database.

7. The computer-implemented method of claim 1, further comprising:
generating, by querying the LLM, a text based on the second question and the historical conversation associated with the user question, wherein the text comprises one or more follow-up questions associated with the second question and one or more citations associated with the one or more follow-up questions; and
extracting, from the one or more follow-up questions, a third question based on the one or more citations and a format instruction from the user device, and
updating the historical conversation associated with the user question by incorporating at least one of the second question or the third question into the historical conversation.

8. A system for generating a question recommendation to a user device, comprising:
one or more memories;
one or more processors each coupled to at least one of the memories and configured to perform operations comprising:
receiving a user question from the user device;
assigning, based on a distance metric between an embedding of the user question and an embedding of a topic cluster in a database, the user question to the topic cluster in the database;
in response to the assigning, ranking one or more topics within the topic cluster in the database from most to least relevant to the user question based on a topic score associated with the one or more topics;
retrieving a first question from the database based on the ranked most relevant topic to the user question;
generating, by querying a large language model (LLM), a second question based on the user question and a historical conversation associated with the user question; and
generating, based on a combination of the first question and the second question, the question recommendation for the user device.

9. The system according to claim 8, wherein the operations further comprise:
generating the topic score for each of the one or more topics based on at least a topic similarity, a topic frequency, or a topic recency.

10. The system according to claim 8, wherein the operations further comprise generating the database, wherein the generating the database comprises:
importing, from one or more data sources into a first dataset, one or more data files comprising the one or more questions and the one or more topics associated with the one or more questions;
generating a second dataset by applying a first data cleaning to the first dataset;
generating one or more embeddings for the one or more topics in the second dataset;
grouping, based on the distance metric, the one or more embeddings in the second dataset into one or more groups, wherein a group of the second dataset comprises the one or more questions associated with the one or more topics within the distance metric;
translating, by querying the LLM, a language of the one or more questions in the second dataset to a default language for the database;
generating a third dataset by applying a second data cleaning to the second dataset;
identifying, by querying the LLM or a natural language processing (NLP) model, a set of named entity recognition (NER) results for the one or more questions in the third dataset;
in response to a majority of results of the set of NER results for the one or more questions having a named entity, flagging the one or more questions in the third dataset as having the named entity, wherein the flagged one or more questions in the third dataset locate the named entity associated with the first question for retrieving the first question from the one or more questions in the database; and
storing the third dataset into the database.

11. The system according to claim 10, wherein the applying the first data cleaning comprises:
deleting, from the first dataset, a row of the first data set with a zero response, an invalid response, or a duplicated response.

12. The system according to claim 10, wherein the applying the second data cleaning comprises:
deleting at least one of a stopword or a punctuation of the one or more questions from the second dataset;
stemming the one or more questions in the second dataset;
applying a plurality of filters to the one or more questions in the second dataset, wherein the plurality of filters comprise a content structure filter, an error filter, a personally identifiable information (PII) filter, a technical domain filter, or a profanity filter; or
applying a grammar checking and a spelling correction to the one or more questions in the second dataset.

13. The system according to claim 8, wherein the operations further comprise:
reducing, based on a dimension reduction model, a dimensionality of the embedding of the user question; and
reducing, based on the dimension reduction model, a dimensionality of the embedding of the topic in the database.

14. The system according to claim 8, wherein the operations further comprise:
generating, by querying the LLM, a text based on the second question and the historical conversation associated with the user question, wherein the text comprises one or more follow-up questions associated with the second question and one or more citations associated with the one or more follow-up questions; and
extracting, from the one or more follow-up questions, a third question based on the one or more citations and a format instruction from the user device, and
updating the historical conversation associated with the user question by incorporating at least one of the second question or the third question into the historical conversation.

15. A non-transitory computer-readable medium having instructions stored thereon that, when executed by one or more processors, cause the one or more processors to perform operations comprising:
receiving a user question from the user device;
assigning, based on a distance metric between an embedding of the user question and an embedding of a topic cluster in a database, the user question to the topic cluster in the database;
in response to the assigning, ranking one or more topics within the topic cluster in the database from most to least relevant to the user question based on a topic score associated with the one or more topics;
retrieving a first question from the database based on the ranked most relevant topic to the user question;
generating, by querying a large language model (LLM), a second question based on the user question and a historical conversation associated with the user question; and
generating, based on a combination of the first question and the second question, the question recommendation for the user device.

16. The non-transitory computer-readable medium according to claim 15, wherein the operations further comprise generating the database, wherein the generating the database comprises:
importing, from one or more data sources into a first dataset, one or more data files comprising the one or more questions and the one or more topics associated with the one or more questions;
generating a second dataset by applying a first data cleaning to the first dataset;
generating one or more embeddings for the one or more topics in the second dataset;
grouping, based on the distance metric, the one or more embeddings in the second dataset into one or more groups, wherein a group of the second dataset comprises the one or more questions associated with the one or more topics within the distance metric;
translating, by querying the LLM, a language of the one or more questions in the second dataset to a default language for the database;
generating a third dataset by applying a second data cleaning to the second dataset;
identifying, by querying the LLM or a natural language processing (NLP) model, a set of named entity recognition (NER) results for the one or more questions in the third dataset;
in response to a majority of results of the set of NER results for the one or more questions having a named entity, flagging the one or more questions in the third dataset as having the named entity, wherein the flagged one or more questions in the third dataset locate the named entity associated with the first question for retrieving the first question from the one or more questions in the database; and
storing the third dataset into the database.

17. The non-transitory computer-readable medium according to claim 16, wherein the applying the first data cleaning comprises:
deleting, from the first dataset, a row of the first data set with a zero response, an invalid response, or a duplicated response.

18. The non-transitory computer-readable medium according to claim 16, wherein the applying the second data cleaning comprises:
deleting at least one of a stopword or a punctuation of the one or more questions from the second dataset;
stemming the one or more questions in the second dataset;
applying a plurality of filters to the one or more questions in the second dataset, wherein the plurality of filters comprise a content structure filter, an error filter, a personally identifiable information (PII) filter, a technical domain filter, or a profanity filter; or
applying a grammar checking and a spelling correction to the one or more questions in the second dataset.

19. The non-transitory computer-readable medium according to claim 15, wherein the operations further comprise:
reducing, based on a dimension reduction model, a dimensionality of the embedding of the user question; and
reducing, based on the dimension reduction model, a dimensionality of the embedding of the topic in the database.

20. The non-transitory computer-readable medium according to claim 15, wherein the operations further comprise:
generating, by querying the LLM, a text based on the second question and the historical conversation associated with the user question, wherein the text comprises one or more follow-up questions associated with the second question and one or more citations associated with the one or more follow-up questions; and
extracting, from the one or more follow-up questions, a third question based on the one or more citations and a format instruction from the user device, and
updating the historical conversation associated with the user question by incorporating at least one of the second question or the third question into the historical conversation.
